(19) United States
(12) Patent Application Publication
(10) Pub. No.: US 2026/0157266 A1
(43) Pub. Date: Jun. 11, 2026

(54) Control Method and Apparatus for Fertigation in Moving Lateral Irrigation Machines

(71) Applicant: China Agricultural University, Beijing (CN)

(72) Inventors: Haijun Yan, Beijing (CN); Shaoxuan Kang, Beijing (CN); Yaojun Li, Beijing (CN); Jingjing Wang, Beijing (CN); Jiali Guo, Beijing (CN); Yuncheng Xu, Beijing (CN)

(21) Appl. No.: 19/409,741

(22) Filed: Dec. 5, 2025

(30) Foreign Application Priority Data
Dec. 5, 2024 (CN) 2024117750333

(51) Int. Cl. A01C 23/00; A01C 23/04; G05B 19/042

(52) U.S. Cl. CPC A01C 23/007; A01C 23/042; G05B 19/042; G05B 2219/2625

(57) ABSTRACT

A control method and apparatus for fertigation in a moving lateral irrigation machine are provided. Based on parameters of the irrigation machine and a fertilizer injection pump, a given irrigation quota, a length of an irrigation field, a fertilizer application amount per hectare, and a fertilizer type, the method calculates an operation duration for the irrigation machine during sprinkler fertigation process for a sub-field, an operating frequency for the fertilizer injection pump, and an operation duration for the irrigation machine during clean water sprinkler irrigation process. This forms a strategy for sub-field comprising performing forward sprinkler fertigation, performing reverse clean water sprinkler irrigation, and subsequently performing forward clean water sprinkler irrigation, while preparing the fertilizer solution required for next stage during clean water sprinkler irrigation phases, thereby avoiding frequent stops. Precise regulation of the irrigation machine's travel speed and the fertilizer injection pump's frequency enables fully automated precise fertigation operations.

### CROSS REFERENCE TO RELATED APPLICATION

This application claims the priority of Chinese Patent Application No. 202411775033.3, entitled “Control Method and Apparatus for Fertigation in Moving Lateral Irrigation Machines”, filed on Dec. 5, 2024, the disclosure of which is incorporated herein by reference in its entirety.

### BACKGROUND OF THE INVENTION

### 1. Field of the Invention

The invention relates to the technical field of fertigation, and particularly to a control method and apparatus for fertigation in moving lateral irrigation machines.

### 2. Description of Related Art

Fertigation technology offers significant benefits in water conservation, fertilizer reduction, and yield increase, and has become a key measure for improving water and fertilizer use efficiency and implementing large-scale grain yield enhancement initiatives. Moving lateral irrigation machines are characterized by their high automation, large area coverage per unit, and strong adaptability, and can significantly reduce water resource consumption and labor costs. Related studies have shown that applying large-scale irrigation machines for sprinkler fertigation can reduce labor input, avoid conflicts with conventional agricultural machinery operations, and improve fertilizer utilization efficiency while enhancing crop yield and quality.

Currently, the widely used large-scale irrigation machines are mainly center-pivot irrigation systems and moving lateral irrigation machines. Center-pivot systems rotate around a central pivot point, irrigating a circular area which cannot cover the four corners of a field. In contrast, moving lateral irrigation machines travel perpendicular to the machine's orientation, irrigating a rectangular area. This makes them suitable for the strip or rectangular fields common in traditional agricultural regions, achieving a coverage rate of over 95%.

However, because the inlet of the main irrigation pipeline for a moving lateral irrigation machine moves with the main drive trolley, the fertilizer injection equipment and storage container are typically installed on the main drive trolley. To maintain the operational stability of the machine, small-volume fertilizer tanks are often selected as storage containers. But for moving lateral irrigation machines with long travel distances, multiple spans, and large control areas, small-volume fertilizer tanks necessitate frequent stops of the machine, severely impacting the efficiency and stability of its fertigation operations. Furthermore, moving lateral irrigation machines operate at relatively low speeds, requiring extended periods to complete Fertigation for long fields. The time interval between sprinkler fertigation and clean water sprinkler irrigation for some field sections can be excessively long, failing to promptly rinse the fertilizer solution intercepted by the crop canopy. This leads to significant evaporation and volatilization of the fertilizer solution, reducing fertilizer utilization efficiency.

Therefore, conducting research on specialized equipment for fertigation in moving lateral irrigation machines suitable for intensive agriculture, along with corresponding irrigation and fertilization strategies, aligns with national policies and practical domestic application requirements. This research is of great significance for improving water and fertilizer use efficiency, increasing crop yields, and protecting soil and groundwater resources.

### SUMMARY OF THE INVENTION

In view of the aforementioned problems, an objective of the invention is to provide a fertigation apparatus with stable fertilizer injection flow rate, suitable for moving lateral irrigation machines. This apparatus can precisely control fertilizer concentration and application amount through an irrigation and fertilization strategy, and achieve fully automated, precise fertigation operations based on a control method. Furthermore, based on a Fertigation strategy involving segmented reciprocating irrigation and fertilization, it effectively solves issues such as frequent stops and fertilizer solution evaporation during the fertigation process of moving lateral irrigation machines, thereby significantly improving the operational efficiency, system stability, and fertilizer utilization rate of Fertigation for these machines.

To achieve the above objective, the invention adopts the following technical scheme:

In a first aspect, the invention provides a control method for fertigation in a moving lateral irrigation machine, used for controlling fertigation equipment. The fertigation equipment comprises a connected moving lateral irrigation machine, a fertilizer injection pump, and a fertilizer storage unit. The control method comprises: acquiring inherent parameters of the irrigation machine, and setting for the current irrigation and fertilization event: a length of the field to be irrigated, a fertilizer application amount per hectare, an irrigation quota, and a fertilizer type; collecting an inlet flow rate of the irrigation machine before starting the current fertilizer injection irrigation, and an E_{c} value or pH value of clean water within the main pipeline of the irrigation machine; based on the inherent parameters of the irrigation machine, the length of the field, the fertilizer application amount per hectare, the irrigation quota, the fertilizer type, and the inlet flow rate before starting fertilizer injection, calculating operational parameters for the irrigation machine and the fertilizer injection pump to form a strategy for the current irrigation and fertilization event; where said strategy specifically comprises dividing the irrigation field into a plurality of sub-fields and performing irrigation and fertilization operations on each sub-field sequentially; where for a currently operating sub-field, the strategy is: first performing forward sprinkler fertigation, then performing reverse clean water sprinkler irrigation, and subsequently performing forward clean water sprinkler irrigation again; and where during the clean water sprinkler irrigation phase, the fertilizer solution required for the next stage is prepared; controlling the fertigation equipment for the moving lateral irrigation machine to execute the strategy for the current irrigation and fertilization event; and during the execution of the strategy, monitoring and performing feedback adjustment of the concentration of the sprinkler-applied fertilizer solution: selecting a corresponding fertilizer concentration inversion prediction model based on the fertilizer type; obtaining a predicted E_{c} value or predicted pH value for the sprinkler-applied fertilizer solution in the current irrigation and fertilization event based on the sprinkler-applied fertilizer concentration and the selected prediction model; comparing this predicted value with the E_{c} value or pH value of the sprinkler-applied fertilizer solution collected after fertilizer injection begins; and generating a control command for the fertigation equipment based on the comparison result.

In an embodiment, the inherent parameters of the irrigation machine comprise: a total length of the irrigation machine, a throw distance of an end sprinkler installed on the irrigation machine, a field water application efficiency, a field slip coefficient, a rated speed of the drive motor, an effective radius of the matched tire, a transmission ratio of the drive motor reducer, a transmission ratio of the wheel reducer, a rated frequency of the fertilizer injection pump, and a verified actual flow rate of the fertilizer injection pump.

In an embodiment, the E_{c} value and the pH value are collected by a conductivity sensor and a pH sensor, respectively, installed downstream of the confluence of the fertilizer injection pipeline and the main pipeline of the irrigation machine. The inlet flow rate is collected by a flow meter installed at the water inlet of the main pipeline of the irrigation machine.

In an embodiment, the specific steps for forming the strategy for the current irrigation and fertilization event comprise: A preset program: determining a coverage area A₀ of the irrigation machine based on the inherent parameters of the irrigation machine. For Sprinkler Fertigation: determining a total fertilizer injection volume V_{f} for the current sprinkler fertigation event based on a given maximum solubility S of the fertilizer at room temperature, the fertilizer application amount per hectare M, and the coverage area A₀ of the irrigation machine; determining a number of fertilizer preparation cycles N for the current sprinkler fertigation event based on the total fertilizer injection volume V_{f} and a volume Vₜ of a fertilizer storage container in the fertilizer storage unit, where a number of sub-fields into which the irrigation field is divided is set equal to the number of fertilizer preparation cycles N; determining an actual fertilizer injection volume V for the current sprinkler fertigation event based on the number of fertilizer preparation cycles N and the volume Vₜ of the fertilizer storage container; determining a length l and an area a of a single divided sub-field based on the length of the irrigation field L_{b}, the coverage area A₀ of the irrigation machine, and the number of fertilizer preparation cycles N for the current sprinkler fertigation event; determining a minimum time tₘᵢₙ for the irrigation machine to traverse a single sub-field in one direction based on the sub-field length l and a maximum travel speed of the irrigation machine; determining a percentage timer setting value x_{f} for the irrigation machine during the sprinkler fertigation process for a single sub-field based on the Inlet flow rate Q₀ of the irrigation machine, a desired fertilizer solution depth h_{f} during sprinkler fertigation, the coverage area A₀ of the irrigation machine, and the minimum traversal time tₘᵢₙ for a single sub-field; calculating an operation duration t_{f} for the irrigation machine during the sprinkler fertigation process for a single sub-field based on the minimum traversal time tₘᵢₙ and the percentage timer setting value x_{f} for Sprinkler Fertigation; determining an operating frequency f for the fertilizer injection pump based on its rated frequency f_{d}, its verified actual flow rate q_{d}, and the operation duration tr for the sprinkler fertigation process in a single sub-field. For clean water sprinkler irrigation: calculating a clean water irrigation depth h_{w} based on the current irrigation quota h and the desired fertilizer solution depth h_{f} during sprinkler fertigation; determining a percentage timer setting value x_{w} for the irrigation machine during the clean water sprinkler irrigation process for a single sub-field based on the inlet flow rate Q₀ of the irrigation machine, the coverage area A₀ of the irrigation machine, the minimum traversal time tₘᵢₙ for a single sub-field, and the clean water irrigation depth h_{w}; calculating an operation duration t_{w} for the irrigation machine during the clean water sprinkler irrigation process for a single sub-field based on the minimum traversal time tₘᵢₙ and the percentage timer setting value x_{w} for clean water sprinkler irrigation.

Finally, the strategy for the current irrigation and fertilization event is formed based on the calculated operation duration t_{f} for the irrigation machine during the sprinkler fertigation process per single sub-field, the operating frequency f of the fertilizer injection pump, the operation duration t_{w} for the irrigation machine during the clean water sprinkler irrigation process per single sub-field, the total operation duration per single sub-field tₐ=t_{f}+t_{w}, and the total duration for the fertigation operation t=Ntₐ.

Furthermore, the coverage area A₀ of the irrigation machine is calculated according to the following formula:

$${A}_{0} = \frac{{L}_{b} [ {L}_{S} + 0.75 ( {R}_{1} + {R}_{2} ) ]}{1 {0}^{- 4}}$$

Where: Lₛ is the total length of the irrigation machine. R₁ and R₂ are the throw distances of the end sprinklers installed on the irrigation machine. For a One-Side moving lateral irrigation machine, Lₛ is the distance from the main drive trolley to the end sprinkler on the truss pipeline, and R₂ is taken as 0. For a Two-Side moving lateral irrigation machine, Lₛ is the distance between end sprinklers on both sides of the irrigation machine truss pipeline.

The total fertilizer injection volume V_{f} for the current sprinkler fertigation event is calculated according to the following formula:

$${V}_{f} = \frac{{MA}_{0}}{S} \times k$$

Where k is a coefficient set to ensure sufficient dissolution of the fertilizer, taken as 1.3 to 1.6.

The actual fertilizer injection volume V for the current sprinkler fertigation event is calculated according to the following formulas:

$$V = {NV}_{t}$$

$$N = \frac{{V}_{f}}{{V}_{t}}$$

Where N is the number of fertilizer preparation cycles for the current sprinkler fertigation event, and Vₜ is the volume of the fertilizer storage container in the fertilizer storage unit. The value of N obtained from the above formula is rounded up to the nearest integer to serve as the number of fertilizer preparation cycles.

The length l and area a of a single sub-field are calculated according to the following formulas:

$$l = \frac{{L}_{b}}{N}$$

$$a = \frac{{A}_{0}}{N}$$

The minimum time tₘᵢₙ for the irrigation machine to traverse a single sub-field in one direction is calculated according to the following formulas:

$${t}_{min} = \frac{l}{{v}_{e}}$$

$${v}_{e} = \frac{2 πη nr}{{i}_{1} {i}_{2}}$$

Where: i₁ is the transmission ratio of the drive motor reducer. i₂ is the transmission ratio of the wheel reducer. n is the rated speed of the drive motor. r is the effective radius of the matched tire. η is the field slip coefficient, which depends on tire tread, tire pressure, and soil compactness, and is taken as 0.92 to 0.97.

The percentage timer setting value x_{f} for the irrigation machine during the sprinkler fertigation process for a single sub-field is calculated according to the following formula and rounded down:

$${x}_{f} = 0.1 \frac{{Q}_{0} {η}_{p} {t}_{min}}{{ah}_{f}}$$

Where: ηₚ is the field water application efficiency, which correlates with wind speed. When wind speed is below 3.4 m/s, ηₚ is taken as 0.8 to 0.9; when wind speed is between 3.4 and 5.4 m/s, ηₚ is taken as 0.7 to 0.8. The value of the desired fertilizer solution depth h_{f} during the sprinkler fertigation process for a single sub-field must not be less than 5 mm.

The operation duration t_{f} for the irrigation machine during the sprinkler fertigation process for a single sub-field is calculated according to the following formula:

$${t}_{f} = \frac{{t}_{min}}{{x}_{f}}$$

The operating frequency f for the fertilizer injection pump is calculated according to the following formula:

$$f = \frac{{Vf}_{d}}{{q}_{d} {t}_{f}}$$

The clean water irrigation depth h_{w} for a single sub-field is calculated according to the following formula:

$${h}_{w} = h - {h}_{f}$$

The percentage timer setting value x_{w} for the irrigation machine during the clean water sprinkler irrigation process for a single sub-field is calculated according to the following formula and rounded down:

$${x}_{w} = 0.2 \frac{{Q}_{0} {η}_{p} {t}_{min}}{{ah}_{w}}$$

The operation duration t_{w} for the irrigation machine during the clean water sprinkler irrigation process for a single sub-field is calculated according to the following formula:

$${t}_{w} = 2 \frac{{t}_{min}}{{x}_{w}}$$

Furthermore, during the execution of the strategy for the current irrigation and fertilization event, monitoring and feedback adjustment of the fertilizer solution concentration is performed, specifically comprising:

Calculating the concentration of the stock fertilizer solution prepared in the fertilizer storage tank of the fertilizer storage unit during the Sprinkler Fertigation process according to the following formula:

$$C = \frac{{MA}_{0}}{V}$$

Where C is the concentration of the stock fertilizer solution; M is the fertilizer application amount per hectare; A₀ is the coverage area of the irrigation machine; V is the actual fertilizer injection volume for the current Sprinkler Fertigation event.

Calculating the concentration of the sprinkler-applied fertilizer solution based on the inlet flow rate Q₀ of the irrigation machine, the verified actual flow rate q_{d} of the fertilizer injection pump, and the prepared stock fertilizer solution concentration, using the following formula:

$${C}_{s} = \frac{{q}_{d}}{{q}_{d} + 1 \; 000 {Q}_{0}} \times C$$

Where Cₛ is the concentration of the sprinkler-applied fertilizer solution.

Selecting a corresponding fertilizer concentration inversion prediction model based on the fertilizer type; this model reflects the functional relationship between the sprinkler-applied fertilizer concentration Cₛ and the E_{c} value or pH value of the sprinkler-applied fertilizer solution.

Inputting the sprinkler-applied fertilizer concentration Cₛ into the selected prediction model to obtain a predicted E_{c} value and a predicted pH value for the sprinkler-applied fertilizer solution in the current irrigation and fertilization event, and comparing this predicted value with the E_{c} value or pH value of the sprinkler-applied fertilizer solution collected after fertilizer injection begins. If the comparison result exceeds a set threshold, a stop signal is issued and a stop report is generated. If the comparison result does not exceed the set threshold, the execution of the current irrigation and fertilization strategy continues until the operation duration of the irrigation machine reaches the total duration t for the fertigation operation, at which point the current irrigation and fertilization event concludes.

Furthermore, when the selected fertilizer is a strong electrolyte, the fertilizer concentration inversion prediction model is:

$${E}_{c} = a {C}_{s} + b$$

Where: E_{c} is the conductivity value. a is a first coefficient, which needs to be calibrated through experiments, b is the E_{c} value of the clean irrigation water before fertilizer injection begins.

When the selected fertilizer is an acidic or alkaline fertilizer, the fertilizer concentration inversion prediction model is:

$$pH = {y}^{{C}_{s}} + z - 1$$

Where: pH is the acidity or alkalinity. y is a second coefficient, which needs to be calibrated through experiments, z is the pH value of the clean irrigation water before fertilizer injection begins.

Furthermore, the strategy for the current irrigation and fertilization event further comprises performing a backwashing operation on the fertilizer injection pump during the clean water sprinkler irrigation phase after completing sprinkler fertigation for the final sub-field, by setting an operation duration t_{c} and a rated operating frequency f_{c} for the fertilizer injection pump during the backwashing process. Herein, t_{c} is set as a fixed duration, typically 10 minutes; and f_{c} is set to the rated frequency of the fertilizer injection pump.

In a second aspect, the invention provides a Fertigation apparatus for a moving lateral irrigation machine, operable according to the control method of any embodiment of the first aspect of the invention. The apparatus comprises fertilizer application equipment, a main drive trolley of the irrigation machine, a control system, and a plurality of pipelines. The fertilizer application equipment comprises a fertilizer injection pump and a fertilizer storage unit. The main drive trolley comprises a traveling mechanism, a main trolley frame mounted on the traveling mechanism, and a main irrigation machine pipeline mounted at a central portion of the main trolley frame.

The fertilizer injection pump is connected via pipelines between the main irrigation machine pipeline and the fertilizer storage unit, and is configured to inject fertilizer solution from the fertilizer storage unit into the main irrigation machine pipeline based on control commands from the control system. An inlet of the fertilizer injection pump is connected via a fertilizer suction pipeline to a fertilizer outlet at a bottom of a fertilizer storage tank within the fertilizer storage unit. An outlet of the fertilizer injection pump is connected via a fertilizer injection pipeline to the main irrigation machine pipeline. The main irrigation machine pipeline is connected via a water make-up pipeline to an inlet of the fertilizer storage tank. A backflush pipeline is connected between the water make-up pipeline and the fertilizer suction pipeline. during the clean water sprinkler irrigation phase after sprinkler fertigation is completed for a final sub-field, the fertilizer injection pump is flushed via the backflush pipeline.

The fertilizer storage unit is configured to prepare a fertilizer solution of a corresponding concentration based on control commands from the control system. The fertilizer storage unit comprises the connected fertilizer storage tank and a fertilizer mixer.

The control system comprises a sensor unit, a valve group, and a first control cabinet and a second control cabinet disposed on one side of the main trolley frame in communication with each other. The sensor unit comprises a liquid level sensor mounted at a top of the fertilizer storage tank, a pressure switch installed on the fertilizer injection pipeline, and a flow meter, a conductivity sensor, and a pH sensor sequentially installed on the main irrigation machine pipeline. The valve group comprises a water make-up motorized valve, a fertilizer suction motorized valve, a fertilizer injection motorized valve, and a backflush motorized valve, respectively installed on corresponding pipelines. The second control cabinet is configured to: calculate operational parameters for the irrigation machine and the fertilizer injection pump based on user-set parameters and the inlet flow rate of the irrigation machine collected by the flow meter before fertilizer injection begins, thereby forming a strategy for the current irrigation and fertilization event and displaying it to the user; control the operation of the fertilizer application equipment, the sensor unit, and the valve group according to the strategy for the current irrigation and fertilization event; and, during the control process, monitor and perform feedback adjustment of the concentration of the sprinkler-applied fertilizer solution. The first control cabinet is configured to: control start/stop, travel speed, and operation time of the irrigation machine, and control start/stop of a main water supply pump for the irrigation machine, according to the strategy for the current irrigation and fertilization event.

In an embodiment, the second control cabinet comprises a frequency converter and a second controller disposed inside a second cabinet body, and a human-machine interface unit disposed on an exterior of the second cabinet body, the second controller integrates an irrigation and fertilization strategy generation module and an irrigation fertilizer concentration control module. The second controller controls an operating frequency of the fertilizer injection pump via the frequency converter. The second controller is connected to the sensor unit, the valve group, and the fertilizer mixer. The first control cabinet comprises a percentage timer and a first controller disposed on an exterior and inside a first cabinet body, respectively. The first controller and the second controller are in communication with each other. The first controller controls the travel speed of the irrigation machine via the percentage timer.

In an embodiment, a fertilizer suction filter and a fertilizer suction manual valve are further installed on the fertilizer suction pipeline. A water make-up filter and a water make-up manual valve are further installed on the water make-up pipeline. A check valve and a fertilizer injection manual valve are further installed on the fertilizer injection pipeline. A manual drain valve is installed at the bottom of the fertilizer storage tank.

Efficacy can be achieved by the invention is as follows: 1) The invention discloses a control strategy for fertigation in a moving lateral irrigation machine based on segmented reciprocating irrigation and fertilization. Compared to traditional strategies, this strategy divides the field into several sub-fields and performs alternating reciprocating irrigation on the sub-fields using a sequence of forward sprinkler fertigation, reverse clean water sprinkler irrigation, and forward clean water sprinkler irrigation. Soaking and mixing of the fertilizer solution occurs during the clean water sprinkler irrigation phases. This avoids frequent stops and fertilizer preparation issues during the fertigation process of the moving lateral irrigation machine, effectively improving the operational efficiency and system stability of fertigation. Furthermore, this strategy significantly reduces the time interval between sprinkler fertigation and clean water sprinkler irrigation. After sprinkler fertigation, immediately applying clean water rinses the fertilizer solution intercepted by the crop canopy, effectively avoiding evaporation and volatilization of the fertilizer solution, improving fertilizer utilization rate, and preventing potential damage to crop leaves from fertilizer residue. Simultaneously, based on relevant parameters of the moving lateral irrigation machine and the fertilizer injection apparatus, and given the desired irrigation depth and fertilizer application amount for the event, this method can calculate operational parameters such as the percentage timer setting for the irrigation machine and the operating frequency of the piston injection pump, thereby forming an irrigation and fertilization strategy. The control system precisely regulates the travel speed of the irrigation machine and the frequency of the fertilizer injection pump based on this strategy, achieving fully automated and precise fertigation operations. 2) The invention discloses a Fertigation apparatus for a moving lateral irrigation machine. This apparatus uses a piston injection pump as the core fertilizer application equipment. Compared to other fertilization equipment, the invention achieves precise adjustment of the fertilizer injection amount without the need for metering devices like flow meters, avoiding issues such as significant fluctuations in fertilizer concentration caused by large pressure variations in large-scale irrigation machines. It thereby reduces costs while achieving precise synergistic application of water and fertilizer. The disclosed dedicated fertigation apparatus for moving lateral irrigation machines is equipped with a backwashing function. During the clean water sprinkler irrigation phase after sprinkler fertigation is completed for the final sub-field, residual fertilizer solution inside the fertilizer injection pump and connecting pipelines can be flushed through the backflush pipeline, preventing damage to the fertigation system from fertilizer residue. The disclosed dedicated fertigation apparatus is equipped with manual valves, allowing control of the apparatus via these manual valves in case of power failure or malfunction of the motorized valves. The disclosed dedicated fertigation apparatus is equipped with safety protection devices. A pressure switch is installed on the fertilizer injection pipeline; if the fertilizer injection pipeline becomes blocked or the injection apparatus fails, causing the pipeline pressure to reach an upper limit, the control system will automatically stop the sprinkler fertigation process and send feedback to the human-machine interface unit, preventing damage from excessive water pressure and enhancing operational safety. 3) The invention enables real-time monitoring and feedback control of the water-fertilizer concentration in the main pipeline of the moving lateral irrigation machine during the fertigation process. Firstly, before the fertilizer injection process begins, the flow meter, conductivity sensor, and pH sensor measure the inlet flow rate and the E_{c} and pH values of the clean irrigation water in the main pipeline, respectively. Then, based on the fertigation strategy provided by the control system, the concentration of the sprinkler-applied fertilizer solution is calculated using relevant formulas. Based on the preset fertilizer type, a corresponding functional relationship between the sprinkler-applied fertilizer concentration and E_{c} or pH is selected to calculate the expected E_{c} or pH value for the sprinkler-applied fertilizer solution in the current strategy. Finally, the calculated E_{c} or pH value is compared with the E_{c} or pH value measured during the fertilizer injection process. If the difference exceeds a set upper limit, the system automatically stops the Sprinkler Fertigation process and provides feedback to the human-machine interface unit.

### BRIEF DESCRIPTION OF THE DRAWINGS

In order to more clearly illustrate technical solutions of embodiments of the invention or the prior art, drawings will be used in the description of embodiments or the prior art will be given a brief description below. Apparently, the drawings in the following description only are some of embodiments of the invention, the ordinary skill in the art can obtain other drawings according to these illustrated drawings without creative effort.

FIG. 1 is an overall flowchart of a control method for fertigation in a moving lateral irrigation machine according to an embodiment of the first aspect of the invention.

FIGS. 2(a), 2(b), 2(c), and 2(d) are schematic diagrams illustrating a segmented reciprocating irrigation and fertilization method in the control method shown in FIG. 1.

FIG. 3 is a flowchart for generating a strategy for a current irrigation and fertilization event in the control method shown in FIG. 1.

FIG. 4 is a flowchart of a method for monitoring and performing feedback control of fertilizer solution concentration during irrigation and fertilization based on the control method described in FIG. 1.

FIG. 5 is an overall schematic structural view of a fertigation apparatus for a moving lateral irrigation machine according to an embodiment of the second aspect of the invention.

FIG. 6 is a schematic structural view of a fertilizer storage unit, a piston injection pump, and associated pipelines in the apparatus shown in FIG. 5.

FIG. 7 is a schematic structural view of the first control cabinet in the apparatus shown in FIG. 5.

FIG. 8 is a schematic structural view of the second control cabinet in the apparatus shown in FIG. 5.

FIG. 9 is an internal structural block diagram of a control system in the apparatus shown in FIG. 5.

### DETAILED DESCRIPTION OF THE PREFERRED EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

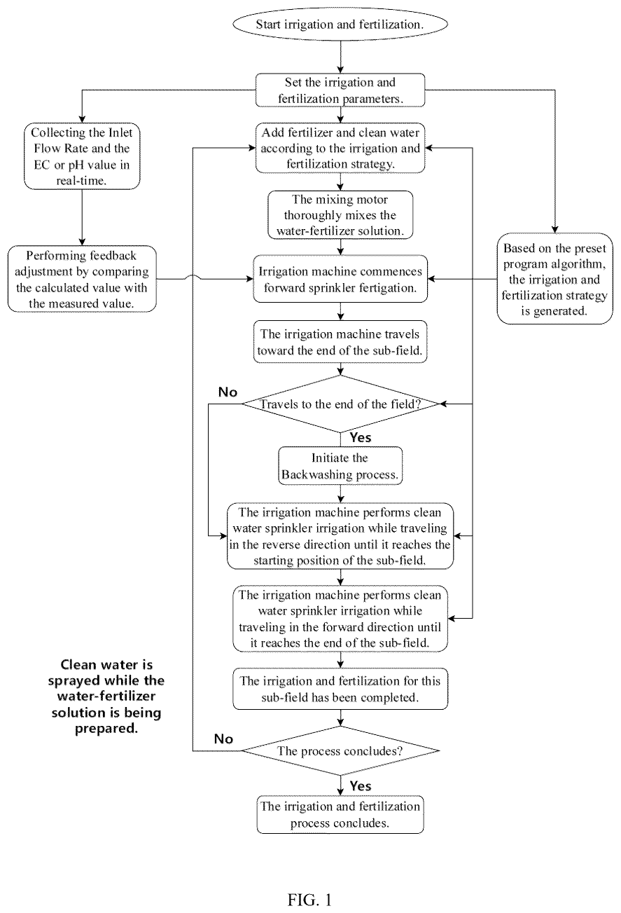

Referring to FIG. 1, a control method for fertigation in a moving lateral irrigation machine according to an embodiment of the first aspect of the invention is used for controlling Fertigation equipment. The fertigation equipment comprises a connected moving lateral irrigation machine (hereinafter referred to as “the irrigation machine”), a fertilizer injection pump, and a fertilizer storage unit. The control method of this embodiment comprises the following steps:
Acquiring inherent parameters of the irrigation machine, and setting for the current irrigation and fertilization event: a length L_{b} (unit: m) of the field to be irrigated, a fertilizer application amount per hectare M (unit: kg), an Irrigation Quota h (unit: mm), and a fertilizer type;
Collecting an inlet flow rate of the irrigation machine before starting the current fertilizer injection irrigation, and an E_{c} value or pH value of clean water within the main pipeline of the irrigation machine;
Based on the inherent parameters of the irrigation machine, the set length L_{b} of the field, the fertilizer application amount per hectare M, the irrigation quota h, the fertilizer type, and the inlet flow rate before starting fertilizer injection, calculating operational parameters for the irrigation machine and the fertilizer injection pump to form a strategy for the current irrigation and fertilization event; this strategy adopts a segmented reciprocating irrigation and fertilization approach, specifically comprising dividing the irrigation field into a plurality of sub-fields and performing irrigation and fertilization operations on each sub-field sequentially; where for a currently operating sub-field, the operation follows a sequence of first performing forward sprinkler fertigation, then performing reverse clean water sprinkler irrigation, and subsequently performing forward clean water sprinkler irrigation again; that is, the irrigation machine runs three passes in each sub-field following a forward-reverse-forward travel direction, and during the clean water sprinkler irrigation phases, the fertilizer solution required for the next stage is prepared;
Controlling the Fertigation equipment to execute the strategy for the current irrigation and fertilization event;
During the execution of the strategy, monitoring and performing feedback adjustment of the concentration of the sprinkler-applied fertilizer solution: selecting a corresponding fertilizer concentration inversion prediction model based on the fertilizer type; obtaining a predicted E_{c} value or predicted pH value for the sprinkler-applied fertilizer solution in the current event based on the sprinkler-applied fertilizer concentration and the selected prediction model; comparing this predicted value with the E_{c} value or pH value of the sprinkler-applied fertilizer solution collected after fertilizer injection begins; and generating a control command for the Fertigation equipment based on the comparison result.

In some embodiments, the inherent parameters of the irrigation machine comprise: a total length of the irrigation machine Lₛ (unit: m), a throw distance R₁, R₂ (unit: m) of end sprinklers installed on the irrigation machine, a field water application efficiency nₚ, a field slip coefficient η, a rated speed of the drive motor n (unit: r/min), an effective radius of the matched tire r (unit: m), a transmission ratio of the drive motor reducer i₁, a transmission ratio of the wheel reducer i₂, a rated frequency of the fertilizer injection pump f_{d} (unit: Hz), and a verified actual flow rate q_{d} (unit: L/h) of the fertilizer injection pump, the value q_{d} can be determined from the drop value measured by a liquid level sensor within the fertilizer storage unit over a defined period.

In some embodiments, a flow meter, a conductivity sensor, and a pH sensor are sequentially disposed on the main pipeline of the irrigation machine. The flow meter is located at the water inlet of the main pipeline and is configured to collect the flow rate of clean water injected into the main pipeline before fertilizer injection begins, i.e., the inlet flow rate Q₀ (unit: m³/h). the conductivity sensor and pH sensor are installed downstream of the confluence of the fertilizer injection pipeline and the main pipeline, and are configured to collect the E_{c} value and pH value of the clean irrigation water before fertilizer injection begins, and the E_{c} value and pH value of the sprinkler-applied fertilizer solution during the fertilizer injection process.

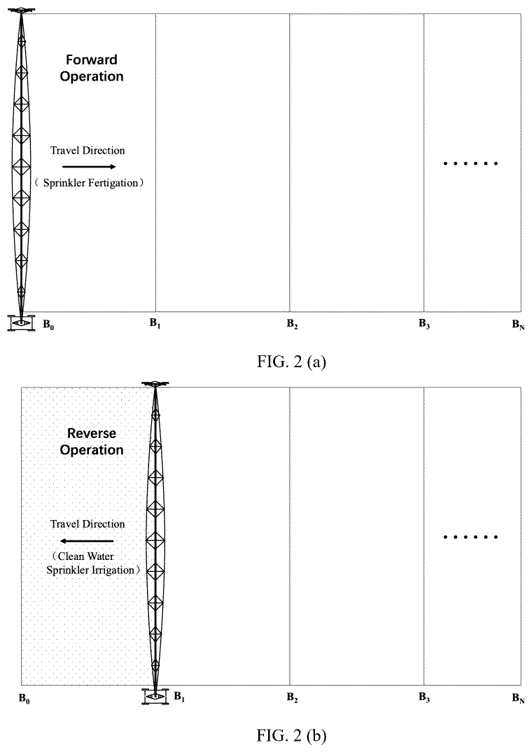

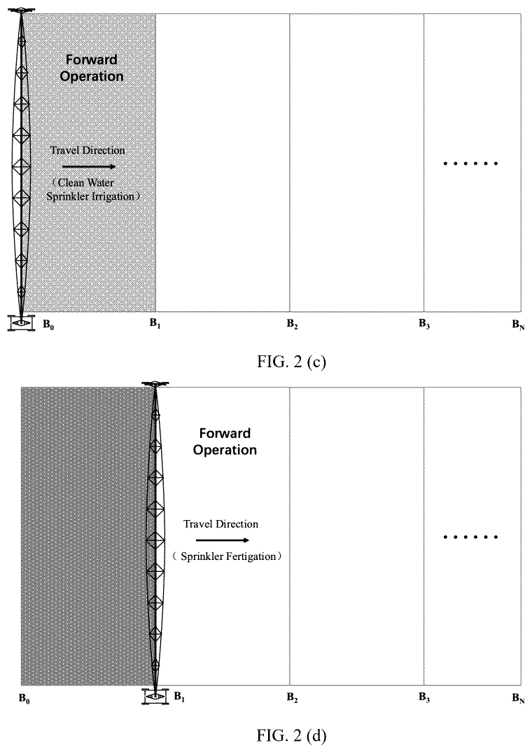

In some embodiments, referring to FIGS. 2(a) to 2(d), which are schematic diagrams illustrating the segmented reciprocating irrigation and fertilization method. As shown in FIG. 2(a), the irrigation field is divided equally into a number of sub-fields. The number of sub-fields is set equal to the number of fertilizer preparation cycles N for the current sprinkler fertigation event. At this point, the irrigation machine is located at B₀ (the starting position of the irrigation field, which is also the starting position of the first sub-field). At this time, the moving lateral irrigation machine begins traveling in the forward direction and performs sprinkler fertigation. As shown in FIG. 2(b), when the irrigation machine reaches B₁ (i.e., the boundary position between the first sub-field and the second sub-field), the sprinkler fertigation ends. The irrigation machine then begins traveling in the reverse direction and initiates the clean water sprinkler irrigation process, while simultaneously preparing the fertilizer solution required for the next stage. As shown in FIG. 2(c), when the irrigation machine returns to B₀, it again travels in the forward direction and continues performing clean water sprinkler irrigation until the irrigation quota is met. As shown in FIG. 2(d), when the irrigation machine returns to B₁, it has completed the entire fertigation process for the first sub-field. Simultaneously, utilizing the fertilizer solution prepared during the previous clean water sprinkler irrigation phase, the irrigation machine begins traveling in the forward direction and performs sprinkler fertigation. The above steps are repeated until the irrigation machine completes the entire fertigation process for the final sub-field. At this point, the irrigation machine is located at BN (the end position of the irrigation field, which is also the end position of the final sub-field), and the current irrigation and fertilization process concludes.

It should be noted that during the clean water sprinkler irrigation phase after completing sprinkler fertigation for the final sub-field, a backwashing operation is performed on the fertilizer injection pump and its connecting pipelines to flush out residual fertilizer solution, preventing potential damage caused by the residue.

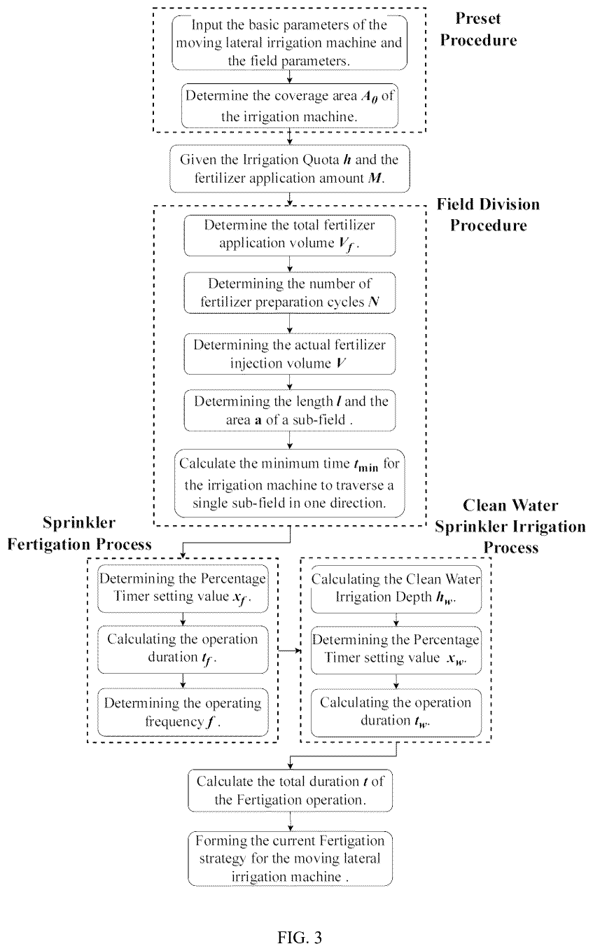

In some embodiments, referring to FIG. 3, which shows a specific flowchart for generating the strategy for the current irrigation and fertilization event. The embodiment of the invention adopts the segmented reciprocating irrigation and fertilization approach, dividing the irrigation field into several sub-fields and performing alternating reciprocating irrigation on the sub-fields using a sequence of forward sprinkler fertigation, reverse clean water sprinkler irrigation, and forward clean water sprinkler irrigation. soaking and mixing of the fertilizer solution occurs during the clean water sprinkler irrigation phases. This avoids frequent stops and fertilizer preparation issues during the fertigation process of the moving lateral irrigation machine, effectively improving the operational efficiency and system stability of fertigation. Furthermore, this strategy significantly reduces the time interval between Sprinkler Fertigation and clean water sprinkler irrigation. After sprinkler fertigation, clean water is immediately applied to rinse the fertilizer solution intercepted by the crop canopy, effectively avoiding evaporation and volatilization of the fertilizer solution, improving fertilizer utilization rate, and preventing potential damage to crop leaves from fertilizer residue.

The specific steps for generating the strategy for the current irrigation and fertilization event in this embodiment comprise:

A preset program: determining a coverage area A₀ (unit: hectare) of the irrigation machine based on the inherent parameters of the irrigation machine.

For sprinkler fertigation: determining a total fertilizer injection volume V_{f} (unit: L) for the current sprinkler fertigation event based on a given maximum solubility S (unit: kg/L) of the fertilizer at room temperature, the set fertilizer application amount per hectare M, and the coverage area A₀ of the irrigation machine. Determining a number of fertilizer preparation cycles N (unit: cycles) for the current sprinkler fertigation event based on the total fertilizer injection volume V_{f} and a volume Vₜ (unit: L) of a fertilizer storage container in the fertilizer storage unit; the number of sub-fields into which the irrigation field is divided is equal to N. Determining an actual fertilizer injection volume V (unit: L) for the current Sprinkler fertigation event based on the number of fertilizer preparation cycles N and the volume Vₜ of the fertilizer storage container. Determining a length l and an area a of a single divided sub-field based on the length of the irrigation field L_{b} (unit: m), the coverage area A₀ of the irrigation machine, and the number of fertilizer preparation cycles N for the current sprinkler fertigation event. Determining a minimum time tₘᵢₙ (unit: h) for the irrigation machine to traverse a single sub-field in one direction based on the single sub-field length I and a maximum travel speed vₑ (unit: m/min) of the irrigation machine. Determining a Percentage Timer setting value x_{f} (unit: %) for the irrigation machine during the sprinkler fertigation process for a single sub-field based on the Inlet Flow Rate Q₀ (unit: m³/h) of the irrigation machine, a desired fertilizer solution depth h_{f} (unit: mm) during Sprinkler Fertigation, the sub-field area a, and the minimum traversal time tₘᵢₙ for a single sub-field. Calculating an operation duration tr (unit: h) for the irrigation machine during the sprinkler fertigation process for a single sub-field based on the minimum traversal time tₘᵢₙ and the percentage timer setting value x_{f} for sprinkler fertigation. Determining an operating frequency f (unit: Hz) for the fertilizer injection pump based on the actual fertilizer injection volume V, the Rated Frequency f_{d} of the fertilizer injection pump, its verified actual flow rate q_{d}, and the operation duration t_{f} for the sprinkler fertigation process in a single sub-field.

For clean water sprinkler irrigation: calculating a clean water irrigation depth h_{w} (unit: mm) based on the current irrigation quota h (unit: mm) and the desired fertilizer solution depth h_{f} during sprinkler fertigation. Determining a percentage Timer setting value x_{w} (unit: %) for the irrigation machine during the clean water sprinkler irrigation process for a single sub-field based on the inlet flow rate Q₀ of the irrigation machine, the sub-field area a, the minimum traversal time tₘᵢₙ for a single sub-field, and the clean water irrigation depth h_{w}. Calculating an operation duration t_{w} (unit: h) for the irrigation machine during the clean water sprinkler irrigation process for a single sub-field based on the minimum traversal time tₘᵢₙ and the percentage timer setting value x_{w} for clean water sprinkler irrigation; this duration corresponds to the time for two passes (one forward and one reverse) of clean water sprinkler irrigation.

For the backwashing process: setting an operation duration t_{c} (unit: min) and a rated operating frequency f_{c} (unit: Hz) for the fertilizer injection pump during the backwashing process, the operation duration t_{c} for the backwashing process is set as a fixed duration, typically 10 minutes. The operating frequency f_{c} for the backwashing process is set to the rated frequency f_{d} of the fertilizer injection pump.

Finally, based on the calculations above—including the operation duration t_{f} and the fertilizer injection pump operating frequency f for the sprinkler fertigation process per single sub-field, the operation duration t_{w} for the clean water sprinkler irrigation process per single sub-field, the operation duration t_{c} and operating frequency f_{c} for the fertilizer injection pump during the backwashing process, the total operation duration per single sub-field tₐ=t_{f}+t_{w} (unit: h), and the total duration for the fertigation operation t=Ntₐ (unit: h)—the strategy for the current irrigation and fertilization event is formed. It should be noted that the backwashing process with duration t_{c} is performed during the clean water sprinkler irrigation phase after completing sprinkler fertigation for the final sub-field. Therefore, the total duration t for the fertigation operation is calculated without considering the backwashing duration t_{c}, and is determined solely by the product of the sum of the sprinkler fertigation duration t_{f} and the clean water sprinkler irrigation duration t_{w} per sub-field and the number of sub-fields N.

Furthermore, the coverage area A₀ of the irrigation machine refers to the total irrigation area controlled by the moving lateral irrigation machine, which is also the fertilization area, calculated by the following formula:

$${A}_{0} = \frac{{L}_{b} [ {L}_{S} + 0.75 ( {R}_{1} + {R}_{2} ) ]}{1 {0}^{- 4}}$$

The total fertilizer injection volume V_{f} for the current sprinkler fertigation event of the irrigation machine can be expressed as:

$${V}_{f} = \frac{{MA}_{0}}{s} \times k$$

Where: S is the maximum solubility of the fertilizer at room temperature (typically taken as 20° C.), in kg/L. k is a coefficient, taken as 1.3 to 1.6 to ensure sufficient dissolution of the fertilizer.

The actual fertilizer injection volume V for the current sprinkler fertigation event can be expressed as:

$$V = {NV}_{t}$$

$$N = \frac{{V}_{f}}{{V}_{t}}$$

Where N is the number of fertilizer preparation cycles for the current sprinkler fertigation event (unit: cycles), and Vₜ is the volume of the fertilizer storage container in the fertilizer storage unit. Since the number of preparation cycles must be an integer, the value of N obtained is rounded up to the nearest integer to serve as the number of fertilizer preparation cycles for the current event.

The length and area of a single sub-field into which the irrigation field is divided can be expressed respectively as:

$$l = \frac{{L}_{b}}{N}$$

$$a = \frac{{A}_{0}}{N}$$

Where l is the sub-field length (unit: m) and a is the sub-field area (unit: hectare).

The minimum time tₘᵢₙ for the irrigation machine to traverse a single sub-field in one direction depends on the maximum travel speed vₑ (unit: m/min) of the irrigation machine and the sub-field length l, calculated by the following formulas:

$${t}_{min} = \frac{l}{{v}_{e}}$$

$${v}_{e} = \frac{2 π η n r}{{i}_{1} {i}_{2}}$$

Where η is the field slip coefficient, which depends on factors such as tire tread, tire pressure, and soil compactness, and is generally taken as 0.92 to 0.97.

The percentage timer setting value for the irrigation machine during the sprinkler fertigation process for a single sub-field determines the travel speed of the irrigation machine during this process. The value x_{f} can be expressed as:

$${x}_{f} = \frac{{Q}_{0} {η}_{p} {t}_{min}}{666.7 a \times {10}^{- 3} {h}_{f}} = 0.1 \frac{{Q}_{0} {η}_{p} {t}_{min}}{a {h}_{f}}$$

Where: since the percentage timer setting value is typically an integer, the calculated value of x_{f} is rounded down to the nearest integer to serve as the setting value. ηₚ is the field water application efficiency, which correlates with wind speed. When wind speed is below 3.4 m/s, ηₚ is taken as 0.8 to 0.9; when wind speed is between 3.4 and 5.4 m/s, ηₚ is taken as 0.7 to 0.8. Relevant studies indicate that a single irrigation depth of less than 5 mm is considered ineffective. To prevent excessive volatilization after fertilizer application, an irrigation depth of 10 mm can be set as the fertilizer solution depth h_{f} for the sprinkler fertigation process in a single sub-field, i.e., h_{f}=10 mm.

The operation duration t_{f} for the irrigation machine during the sprinkler fertigation process for a single sub-field can be expressed as:

$${t}_{f} = \frac{{t}_{min}}{{x}_{f}}$$

The operating frequency f for the fertilizer injection pump can be calculated by the following formula:

$$f = \frac{V {f}_{d}}{{q}_{d} {t}_{f}}$$

Where the rated frequency f_{d} of the fertilizer injection pump is taken as 50 Hz.

The clean water irrigation depth h_{w} for a single sub-field can be expressed as:

$${h}_{w} = h - {h}_{f}$$

Where h is the Irrigation quota for the fertigation operation of the irrigation machine, in mm.

The percentage timer setting value x_{w} for the irrigation machine during the clean water sprinkler irrigation process for a single sub-field determines the travel speed of the irrigation machine during this process. The value x_{w} can be expressed as:

$${x}_{w} = 0.1 \times \frac{{Q}_{0} {η}_{p} {t}_{min}}{a \times \frac{{h}_{w}}{2}} = 0.2 \frac{{Q}_{0} {η}_{p} {t}_{min}}{{ah}_{w}}$$

Where the calculated value of x_{w} is rounded down to the nearest integer to serve as the percentage timer setting value for the clean water sprinkler irrigation process in a single sub-field.

The operation duration t_{w} for the irrigation machine during the clean water sprinkler irrigation process for a single sub-field can be expressed as:

$${t}_{w} = 2 \frac{{t}_{min}}{{x}_{w}}$$

In some embodiments, referring to FIG. 1, specific steps for controlling the fertigation equipment to execute the strategy for the current irrigation and fertilization event are as follows:

First, according to the strategy for the current irrigation and fertilization event, an appropriate amount of fertilizer is added to the fertilizer storage tank of the fertilizer storage unit while clean water is simultaneously injected. Upon reaching the set water level, the water-fertilizer solution within the storage tank is thoroughly mixed. Concurrently, based on the said strategy, precise control is applied to the irrigation machine and the Fertilizer Injection Pump, initiating forward Sprinkler Fertigation by the irrigation machine. When the irrigation machine reaches the end of the sub-field, it switches to reverse Clean Water Sprinkler Irrigation. After the irrigation machine returns to the starting position of the sub-field, it performs forward Clean Water Sprinkler Irrigation until it again reaches the end of the sub-field, simultaneously satisfying the Irrigation Quota for that sub-field. A determination is made based on the current strategy to assess whether the fertilization process is complete. If not, the aforementioned irrigation process is repeated until the current irrigation and fertilization event concludes. Furthermore, by collecting data in real-time, including the Inlet Flow Rate of the irrigation machine, E_{c} values, and pH values, and selecting a corresponding fertilizer concentration inversion prediction model based on the preset fertilizer type, information regarding the water and fertilizer application amount during the irrigation and fertilization process is inversely deduced in real-time. This yields a predicted E_{c} value or predicted pH value for the sprinkler-applied fertilizer solution in the current event, thereby providing feedback to the irrigation and fertilization process.

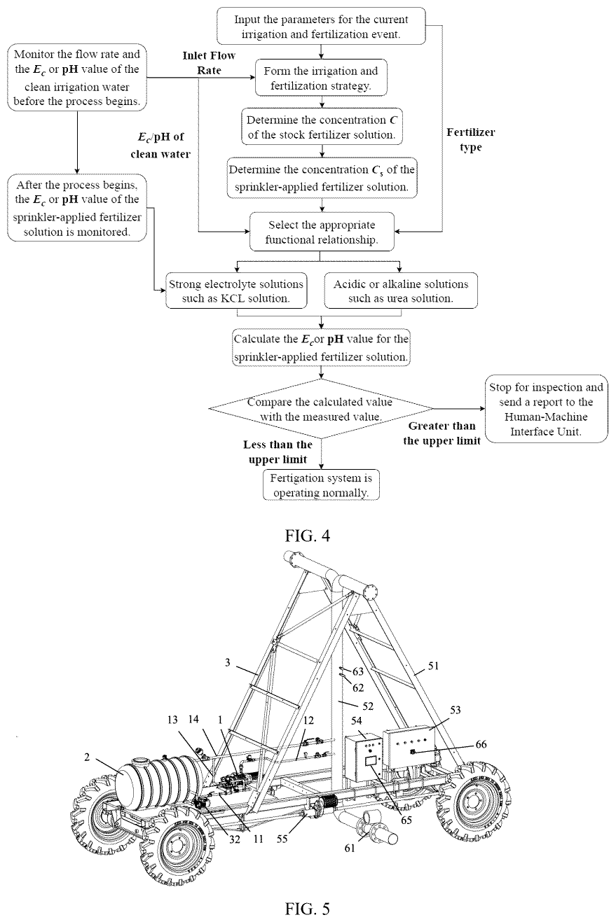

In some embodiments, referring to FIG. 4, specific steps for monitoring and performing feedback adjustment of the fertilizer solution concentration during the execution of the strategy for the current irrigation and fertilization event comprise:

The concentration C of the stock fertilizer solution prepared in the storage tank during the sprinkler fertigation process of the moving lateral irrigation machine can be calculated by the following formula:

$$C = \frac{M {A}_{0}}{V}$$

Where C is the concentration of the stock fertilizer solution, kg/L; M is the fertilizer application amount per hectare, kg; A₀ is the coverage area of the irrigation machine, hectare; V is the actual fertilizer injection volume for the current sprinkler fertigation event, L.

The concentration Cₛ of the sprinkler-applied fertilizer solution is calculated based on the Inlet Flow Rate Q₀ of the irrigation machine, the verified actual flow rate q_{d} of the Fertilizer Injection Pump, and the prepared stock fertilizer solution concentration, using the following formula:

$${C}_{s} = \frac{{q}_{d}}{{q}_{d} + 1000 {Q}_{0}} \times C$$

Where Cₛ is the concentration of the sprinkler-applied fertilizer solution, kg/L, referring to the concentration of the fertilizer solution sprayed by the sprinklers of the irrigation machine, i.e., the fertilizer concentration in the main pipeline of the irrigation machine.

A corresponding fertilizer concentration inversion prediction model is selected based on the fertilizer type. This model reflects the functional relationship between the sprinkler-applied fertilizer concentration Cₛ and the E_{c} value or pH value of the sprinkler-applied fertilizer solution.

For strong electrolytes such as potassium chloride, ammonium dihydrogen phosphate, potassium nitrate, potassium sulfate, etc., the electrical conductivity of their solutions is very strong. The functional relationship between the sprinkler-applied fertilizer concentration and the E_{c} is as follows:

$${E}_{c} = a {C}_{s} + b$$

Where: E_{c} is the electrical conductivity, μS/cm. a is a first coefficient, calibrated through experiments (Using potassium chloride as an example, measure the E_{c} values of potassium chloride solutions at concentrations of 0.05%, 0.1%, 0.15%, 0.2%, 0.25%, 0.3%, 0.35%, 0.4%, 0.45%, 0.5%, 0.55%, 0.6% using an E_{c} meter, and fit the experimental results to the above formula to calibrate coefficient a). b is the measured E_{c} value of the clean water, i.e., the E_{c} value of the clean irrigation water collected by the conductivity sensor before fertilizer injection begins, μS/cm.

For acidic or alkaline solutions such as urea or compound fertilizer solutions, the functional relationship between the sprinkler-applied fertilizer concentration and the pH is as follows:

$$pH = {y}^{{c}_{s}} + z - 1$$

Where: pH is the acidity or alkalinity. y is a coefficient, calibrated through experiments (The calibration process can refer to the calibration process for coefficient a described above). z is the measured pH of the clean water, i.e., the pH value of the clean irrigation water collected by the pH sensor before fertilizer injection begins.

Based on the above functional relationships, the relationship between the sprinkler-applied fertilizer concentration of different types of fertilizers in the main pipeline of the irrigation machine and the E_{c} or pH can be established.

The sprinkler-applied fertilizer concentration Cₛ is input into the selected prediction model to obtain the predicted E_{c} value and predicted pH value for the sprinkler-applied fertilizer solution in the current irrigation and fertilization event. These predicted values are compared with the E_{c} value or pH value of the sprinkler-applied fertilizer solution collected after fertilizer injection begins. If the comparison result exceeds a set threshold, a stop signal is issued and a stop report is generated. By adding water or fertilizer, the comparison result is adjusted to not exceed the set threshold. Subsequently, the execution of the current irrigation and fertilization strategy resumes until the operation duration of the irrigation machine reaches the total duration t for the Fertigation operation, at which point the current irrigation and fertilization event concludes.

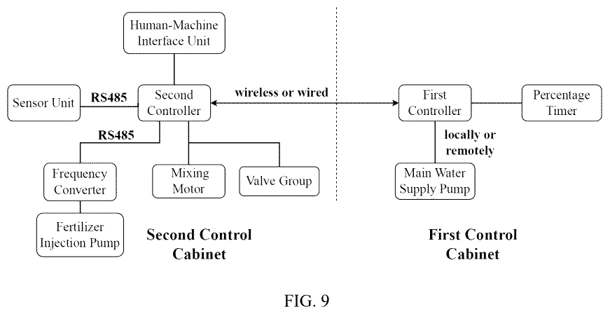

Referring to FIGS. 5-9, a Fertigation apparatus for a moving lateral irrigation machine according to an embodiment of the second aspect of the invention primarily comprises fertilizer application equipment, a main drive tower 3 of the irrigation machine, a control system, and a plurality of pipelines. The fertilizer application equipment comprises a fertilizer injection pump 1 and a fertilizer storage unit 2. The main drive tower 3 comprises a traveling mechanism 55, a main tower frame 51 mounted on the traveling mechanism 55, and a main irrigation machine pipeline 52 mounted at a central portion of the main tower frame 51.

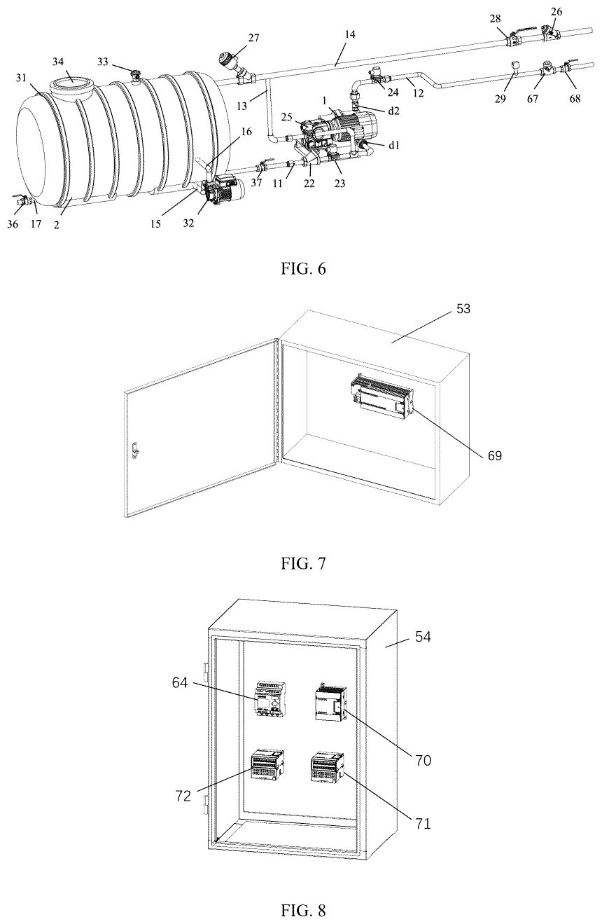

As shown in FIGS. 5-6, the fertilizer injection pump 1 is a piston injection pump, connected via pipelines between the main irrigation machine pipeline 52 and the fertilizer storage unit 2, and is configured to inject fertilizer solution from the fertilizer storage unit 2 into the main irrigation machine pipeline 52 based on control commands from the control system. Specifically, an inlet d1 of the fertilizer injection pump 1 is connected via a fertilizer suction pipeline 11 to a fertilizer outlet at a bottom of a fertilizer storage tank 31 within the fertilizer storage unit 2. A fertilizer suction filter 22 is installed on the fertilizer suction pipeline 11. An outlet d2 of the fertilizer injection pump 1 is connected via a fertilizer injection pipeline 12 to the main irrigation machine pipeline 52. The main irrigation machine pipeline 52 is connected via a water make-up pipeline 14 to an inlet at a top of the fertilizer storage tank 31. A water make-up filter 26 is installed on the water make-up pipeline 14. A backflush pipeline 13 is connected between the water make-up pipeline 14 and the fertilizer suction pipeline 11. During the clean water sprinkler irrigation phase after sprinkler fertigation is completed for the final sub-field, the fertilizer injection pump 1 is flushed via the backflush pipeline 13 to prevent damage from residual fertilizer solution.

As shown in FIG. 6, the fertilizer storage unit 2 in this embodiment is configured to prepare a fertilizer solution of a corresponding concentration based on control commands from the control system, and primarily comprises the fertilizer storage tank 31, a fertilizer mixer, and a storage tank cover 34. The fertilizer storage tank 31 is specifically a horizontal fertilizer tank, placed in front of the main drive tower 3. The fertilizer mixer comprises a circulation pump 32, a circulation pump inlet pipeline 15, and a circulation pump outlet pipeline 16. The circulation pump 32 is mounted on a side of the fertilizer storage tank 31. An inlet of the circulation pump 32 is connected via the circulation pump inlet pipeline 15 to the bottom of the fertilizer storage tank 31. The circulation pump outlet pipeline 16 connects an outlet of the circulation pump 32 to a middle portion of the fertilizer storage tank 31. The circulation pump 32 is configured to drive thorough mixing of the water-fertilizer solution within the fertilizer storage tank 31 based on control commands from the control system. The storage tank cover 34 is connected to the fertilizer storage tank 31 via threads.

As shown in FIGS. 5-6, the control system comprises a sensor unit, a valve group, and a first control cabinet 53 and a second control cabinet 54 suspended on one side of the main tower frame 51 and connected to each other. Where:

The sensor unit comprises a liquid level sensor 33 mounted at the top of the fertilizer storage tank 31, a pressure switch 29 installed on the fertilizer injection pipeline 12, and a flow meter 61, a conductivity sensor 62, and a pH sensor 63 sequentially installed on the main irrigation machine pipeline 52. The liquid level sensor 33 is configured to collect liquid level information inside the fertilizer storage tank 31 in real time. The pressure switch 29 is configured to collect the internal pressure of the fertilizer injection pipeline 12 in real time. The flow meter 61 is located at the water inlet of the main irrigation machine pipeline 52 and is configured to collect the inlet flow rate. The conductivity sensor 62 and pH sensor 63, installed downstream of the confluence of the fertilizer injection pipeline 12 and the main irrigation machine pipeline 52, are configured to collect the E_{c} value and pH value of the clean irrigation water before fertilizer injection begins and the E value and pH value of the sprinkler-applied fertilizer solution during the fertilizer injection process.

The valve group comprises: a water make-up manual valve 28 and a water make-up motorized valve 27 installed on the water make-up pipeline 14; a manual drain valve 36 installed at the bottom of the fertilizer storage tank 31; a fertilizer suction manual valve 37 and a fertilizer suction motorized valve 23 installed on the fertilizer suction pipeline 11; a fertilizer injection motorized valve 24, a check valve 67, and a fertilizer injection manual valve 68 installed on the fertilizer injection pipeline 12, where the check valve 67 and the fertilizer injection manual valve 68 are disposed proximate to the main irrigation machine pipeline 52; and a backflush motorized valve 25 installed on the backflush pipeline 13.

As shown in FIGS. 7-9, the control cabinet 53 comprises a percentage timer 66 and a first controller 69 disposed on an exterior and inside a first cabinet body, respectively. The second control cabinet 54 comprises a frequency converter 64 and a second controller 70 disposed inside a 7 second cabinet body, and a human-machine interface unit 65 disposed on an exterior of the second cabinet body. The second controller 70 integrates an irrigation and fertilization strategy generation module 71 and an irrigation fertilizer concentration control module 72. The first controller 69 and the second controller 70 are in communication via wireless or wired means.

The human-machine interface unit 65 comprises a liquid crystal display screen, configured to allow a user to set parameters for the current irrigation and fertilization event, including the length of the field to be irrigated, the fertilizer application amount per hectare, the irrigation quota, and the fertilizer type, and to display the real-time operational status of the fertigation apparatus to the user.

The irrigation and fertilization strategy generation module 71 is configured to calculate operational parameters for the irrigation machine and the Fertilizer Injection Pump based on the user-set parameters and the inlet flow rate of the irrigation machine collected by the flow meter 61 before fertilizer injection begins, thereby forming a strategy for the current irrigation and fertilization event and transmitting it to the human-machine interface unit 65 for display.

The irrigation fertilizer concentration control module 72 is configured to monitor and adjust the concentration of the irrigation fertilizer solution during the sprinkler fertigation process: selecting a corresponding fertilizer concentration inversion prediction model based on the fertilizer type; utilizing the E_{c} value and pH value of the clean irrigation water collected before fertilizer injection begins to inversely deduce, in real time, information regarding the water and fertilizer application amount during the irrigation and fertilization process; comparing this deduced information with the E_{c} value and pH value of the sprinkler-applied fertilizer solution collected after fertilizer injection begins; and generating a control command based on the comparison result. Specifically, if the comparison result exceeds a set threshold, the second controller 70 communicates with the first controller 69 to issue a stop signal to halt the current irrigation and fertilization event and sends a report to the human-machine interface unit. during the stoppage, water is added to or fertilizer is added into the fertilizer storage tank 31 based on the comparison result until the comparison result no longer exceeds the set threshold, after which the execution of the current irrigation and fertilization strategy resumes until the event concludes.

The first controller 69 is directly connected to the percentage timer 66 and is connected, locally or remotely, to a main water supply pump for the irrigation machine. It is configured to control the start/stop, operation time of the irrigation machine, and the start/stop of the main water supply pump according to the strategy for the current irrigation and fertilization event generated by the irrigation and fertilization strategy generation module 71, and to control the travel speed of the irrigation machine via the percentage timer 66.

The frequency converter 64, controlled by the second controller 70, is directly connected to the fertilizer injection pump 1 and is configured to change the rotational speed of the motor of the fertilizer injection pump 1, thereby achieving control of the flow rate of the fertilizer injection pump 1.

The second controller 70 is directly connected to the valve group, the circulation pump 32 in the fertilizer application equipment, and the liquid crystal display screen in the human-machine interface unit 65, and is linked to the sensor unit via an RS-485 serial bus standard. The second controller 70 is configured to control the operation of the fertilizer application equipment, the sensor unit, and the valve group according to the strategy for the current irrigation and fertilization event generated by the irrigation and fertilization strategy generation module 71 and the control commands generated by the irrigation fertilizer concentration control module 72.

The specific operational workflow of the fertigation apparatus for a moving lateral irrigation machine according to the second aspect of the invention is described below: 1) Starting the Fertigation apparatus of this embodiment. Before injecting fertilizer into the main irrigation machine pipeline 52, the user first inputs parameters for the current irrigation and fertilization event, including the fertilizer application amount per hectare M, the irrigation quota h, and the fertilizer type, into the human-machine interface unit 65. The irrigation and fertilization strategy generation module 71 within the second control cabinet 54 then divides the field into several sub-fields and calculates operational parameters such as the percentage timer setting for the irrigation machine, the operating frequency of the piston injection pump, the operation duration per single sub-field, and the total duration of the fertigation operation. This forms the strategy for the current irrigation and fertilization event, which is then output via the human-machine interface unit 65. 2) The cover 34 of the fertilizer storage tank is opened, and the fertilizer required for a single sub-field is poured in. The first controller 69 within the first control cabinet 53 starts the main water supply pump of the moving lateral irrigation machine to fill the main irrigation machine pipeline 52 with water. Subsequently, the second controller 70 opens the Water Make-up Motorized Valve 27, allowing clean water to be injected into the fertilizer storage tank 31 via the water make-up pipeline 14. When the Liquid Level Sensor 33 detects that the liquid level inside the fertilizer storage tank 31 has reached the preset water level, the second controller 70 issues a control command to close the Water Make-up Motorized Valve 27, and the first controller 69 issues a control command to stop the main water supply pump of the irrigation machine. Simultaneously, the second controller 70 activates the circulation pump 32 to ensure thorough mixing and dissolution of the water-fertilizer solution within the fertilizer storage tank 31. 3) After the fertilizer is fully dissolved, the first controller 69 starts the main water supply pump again to supply water to the main irrigation machine pipeline 52, once the sprinklers begin spraying water, the moving lateral irrigation machine starts traveling from the starting position of the current operating sub-field according to the setting of the percentage timer 66. At the same time, via the second controller 70, the piston injection pump 1 is activated, and the fertilizer suction motorized valve 23 and the fertilizer injection motorized valve 24 are opened, the fully dissolved fertilizer solution is drawn from the fertilizer storage tank 31 through the fertilizer suction pipeline 11, passes through the fertilizer suction filter 22, and enters the inlet d1 of the piston injection pump 1, the fertilizer solution is then injected from the outlet d2 of the piston injection pump 1 into the main irrigation machine pipeline 52 via the fertilizer injection pipeline 12. The moving lateral irrigation machine thus begins spraying the fertilizer solution onto the current operating sub-field. During this process, the second controller 70 controls the flow rate of the Piston Injection Pump 1 via the frequency converter 64. 4) When the liquid level sensor 33 detects that the liquid level in the fertilizer storage tank 31 has reached a lower limit, it automatically sends a signal to the second controller 70. The second controller 70 then deactivates the piston injection pump 1 and closes the fertilizer suction motorized valve 23 and the fertilizer injection motorized valve 24. After the piston injection pump 1 stops, the irrigation machine, having just reached the end position of the current sub-field, initiates the reverse clean water sprinkler irrigation process. Upon the irrigation machine returning to the starting position of the current sub-field, it begins the forward clean water sprinkler irrigation process. For the clean water sprinkler irrigation process, the first controller 69 continues to control the moving lateral irrigation machine to travel at the speed set by the irrigation and fertilization strategy until the machine again reaches the end of the current sub-field, precisely meeting the irrigation quota for that sub-field. After completing the entire fertigation process for the current sub-field, a check is performed based on whether the elapsed operation time of the Fertigation process has reached t to determine if the overall fertigation process is complete. If not, the process returns to step 2) and repeats until the Fertigation process concludes.

Furthermore, the invention performs a backwashing process during the clean water sprinkler irrigation phase after completing sprinkler fertigation for the final sub-field. For the backwashing process, the second controller 70 opens the backflush motorized valve 25, the fertilizer injection motorized valve 24, and activates the piston injection pump 1. Clean water from the main irrigation machine pipeline 52 passes through the water make-up filter 26, then flows through the water make-up pipeline 14, the backflush pipeline 13, and the fertilizer suction pipeline 11 into the inlet d1 of the piston injection pump 1. The residual fertilizer solution is then flushed from the outlet d2 of the piston injection pump 1 into the main irrigation machine pipeline 52 via the fertilizer injection pipeline 12. Once the set backwashing time, i.e., the operation duration t_{c} for the fertilizer Injection Pump during backwashing, is reached, the second controller 70 closes the backflush motorized valve 25, the fertilizer injection motorized valve 24, and deactivates the piston injection pump 1, concluding the backwashing process.

Moreover, the invention enables real-time monitoring and feedback control of the fertilizer solution concentration in the main irrigation machine pipeline 52 during the irrigation and fertilization process. First, before the fertilizer injection process begins, the flow meter 61, conductivity sensor 62, and pH sensor 63 measure the inlet flow rate and the E_{c} and pH values of the clean irrigation water in the main pipeline 52, respectively. Then, based on the strategy for the current irrigation and fertilization event generated by the strategy generation module 71, the concentration of the sprinkler-applied fertilizer solution is calculated using the aforementioned formulas. Based on the preset fertilizer type, a corresponding functional relationship between the sprinkler-applied fertilizer concentration and E_{c} or pH is selected to calculate the expected E_{c} or pH value for the sprinkler-applied fertilizer solution in the current strategy. Finally, the calculated EC or pH value is compared with the E_{c} or pH value measured during the fertilizer injection process. If the difference exceeds a set upper limit, the first controller 69 and the second controller 70 issue shutdown commands to their respective controlled devices to stop the irrigation and fertilization process and provide feedback to the human-machine interface unit 65.

In the above embodiment, the pressure switch 29 is used to monitor the internal pressure of the fertilizer injection pipeline 12 in real time and transmit it to the second controller 70. If a malfunction occurs in the fertilizer injection pipeline 12 or the fertilizer injection pump 1, causing the internal pressure to exceed the maximum working pressure of the piston injection pump 1, the second controller 70 sends a shutdown command to the piston injection pump 1 to prevent damage to the pump and the pipeline from excessive outlet pressure and to avoid safety incidents.

In the above embodiment, if a motorized valve fails, manual control of the fertigation application can be achieved using the water make-up manual valve 28, the manual drain valve 36, the fertilizer suction manual valve 37, and the fertilizer injection manual valve 68.

### Example 1

An embodiment of the present application uses wheat as an example:

The applied fertilizer is potassium chloride, with an application amount per hectare M of 60 kg and a current irrigation quota h of 25 mm. The inlet flow rate of the irrigation machine measured by the sensor is 150 m³/h, and the E_{c} value of the clean irrigation water is 771.48 μS/cm. At room temperature, 0.342 kilograms of potassium chloride can be dissolved per liter of water, thus:

$$S = 0.3 \; 42 kg / L$$

The irrigation machine is a One-Side moving lateral irrigation machine. The distance from the main drive tower to the end sprinkler on the truss pipeline is 165 m, and the throw distance of the end sprinkler installed on the irrigation machine is 6 m. The length of the irrigation field is 750 m. Thus, the coverage area of the moving lateral irrigation machine is:

$${A}_{0} = \frac{{L}_{b} [ {L}_{S} + 0.75 ( {R}_{1} + {R}_{2} ) ]}{1 {0}^{4}} = \frac{750 [ 165 + 0.75 \times ( 6 + 0 ) ]}{{10}^{4}} = 12.7 {hm}^{2}$$

The total fertilizer injection volume V_{f} for the current fertilization event of the moving lateral irrigation machine can be expressed as:

$${V}_{f} = \frac{M {A}_{0}}{S} \times k = \frac{60 \times 12.7}{0.342} \times 1.5 = 3345.6 L$$

The volume of the fertilizer storage container in the fertilization equipment for the current sprinkler fertigation event is 1000 L. Thus, the number of fertilizer preparation cycles N is:

$$N = \frac{{V}_{f}}{{V}_{t}} = \frac{3345.6}{1000} = 3.346$$

Rounded up, the number of fertilizer preparation cycles is N=4 cycles. The actual fertilizer injection volume V is:

$$V = N {V}_{t} = 4 \times 1000 = 4000 L .$$

The length and area of the sub-fields divided during the current sprinkler fertigation process are respectively:

$$l = \frac{{L}_{b}}{N} = \frac{750}{4} = 187.5 m$$

$$a = \frac{{A}_{0}}{N} = \frac{12.7}{4} = 3.18 {hm}^{2}$$

The rated speed of the drive motor of this irrigation machine is 1425 r/min, the effective radius of the matched tire is 0.6325 m, the transmission ratio of the drive motor reducer is 40:1, the transmission ratio of the wheel reducer is 50:1, and the field slip coefficient is taken as 0.95, thus, the minimum time tₘᵢₙ for the irrigation machine to traverse a single sub-field in one direction is:

$${t}_{min} = \frac{{i}_{1} {i}_{2} l}{2 π η n r} = \frac{40 \times 50 \times 187.5}{2 \times π \times 0.95 \times 1425 \times 0.6325} = 69.7 min = 1.16 h$$

The measured wind speed at this time is 2.3 m/s, and the field water application efficiency is taken as 0.85. Thus, the percentage timer setting value x_{f} for the moving lateral irrigation machine during the sprinkler fertigation process is:

$${x}_{f} = 1.5 \frac{{Q}_{0} {η}_{p} {t}_{min}}{a {h}_{f}} = 0.1 \times \frac{150 \times 0.85 \times 1.16}{3.18 \times 10} \times 100 \% = 46.53 \%$$

Rounded down, the percentage timer setting value x_{f} for the moving lateral irrigation machine during the sprinkler fertigation process is x_{f}=46%.

The operation duration tr for the irrigation machine during the sprinkler fertigation process for a single sub-field is:

$${t}_{f} = \frac{{t}_{min}}{{x}_{f}} = \frac{1.16}{46 \%} = 2.52 h$$

The verified actual flow rate of the fertilizer injection pump is 625.5 L/h. Thus, the operating frequency f of the piston injection pump is:

$$f = \frac{{V}_{t} {f}_{d}}{{q}_{d} {t}_{f}} = \frac{1000 \times 50}{625.5 \times 2.52} = 31.72 Hz$$

Rounded up, the operating frequency f of the piston injection pump during the sprinkler fertigation process is f=32 Hz.

In the fertigation operation of the irrigation machine, sprinkler fertigation and clean water sprinkler irrigation must be coordinated. Clean water sprinkler irrigation needs to be performed before each sprinkler fertigation to improve fertilization uniformity and even pose a risk of seedling burn. After sprinkler fertigation, clean water sprinkler irrigation of a certain depth must be applied to meet the crop's irrigation quota and to rinse the leaf surfaces. Thus, the current clean water irrigation depth is:

$${h}_{w} = h - {h}_{f} = 25 - 10 = 15 mm$$

The Percentage Timer setting value x_{w} for the moving lateral irrigation machine during the clean water sprinkler irrigation process is:

$${x}_{w} = 0.2 \frac{{Q}_{0} {η}_{p} {t}_{min}}{a {h}_{w}} = 0.2 \times \frac{150 \times 0.85 \times 1.16}{3.18 \times 15} \times 100 \% = 62.04 \%$$

Rounded down, the Percentage Timer setting value x_{w} for the moving lateral irrigation machine during the Sprinkler Fertigation process is x_{w}=62%.

The operation duration t_{w} for the irrigation machine during the clean water sprinkler irrigation process is:

$${t}_{w} = 2 \frac{{t}_{min}}{{x}_{w}} = 2 \times \frac{1.16}{62 \%} = 3.74 h$$

Thus, the total operation duration per single sub-field is:

$${t}_{a} = {t}_{f} + {t}_{w} = 2.52 + 3.74 = 6.26 h$$

The total duration for the fertigation operation of the irrigation machine is:

$$t = N {t}_{a} = 4 \times 6.26 = 25.04 h$$

The specific workflow for the current fertigation event is as follows:

| | | | | Frequency | |
|---|---|---|---|---|---|
| | | | Percentage | of the | Duration |
| | | Forward/ | timer | piston | of the |
| | | reverse | setting | injection | irrigation |
| Number | Process | operation | value | pump | machine |
| 1 | Fertigation | Forward | 46% | 32 Hz | 2.52 h |
| 2 | Clean water | Reverse | 62% | / | 1.87 h |
| 3 | Clean water | Forward | 62% | / | 1.87 h |
| 4 | Fertigation | Forward | 46% | 32 Hz | 2.52 h |
| 5 | Clean water | Reverse | 62% | / | 1.87 h |
| 6 | Clean water | Forward | 62% | / | 1.87 h |
| 7 | Fertigation | Forward | 46% | 32 Hz | 2.52 h |
| 8 | Clean water | Reverse | 62% | / | 1.87 h |
| 9 | Clean water | Forward | 62% | / | 1.87 h |
| 10 | Fertigation | Forward | 46% | 32 Hz | 2.52 h |
| 11 | Clean water | Reverse | 62% | / | 1.87 h |
| 12 | Clean water | Forward | 62% | / | 1.87 h |

The concentration C of the stock fertilizer solution prepared in the fertilizer storage tank during the sprinkler fertigation process of the irrigation machine is:

$$C = \frac{{MA}_{0}}{V} = \frac{60 \times 12.7}{4000} = 0.1 \; 91 kg / L$$

After the fertilization process begins, the concentration Cₛ of the potassium chloride fertilizer solution in the main pipeline mixture at this time can be calculated as:

$${C}_{S} = \frac{{q}_{d}}{{q}_{d} + 1000 {Q}_{0}} \times C = \frac{32 \div 50 \times 625.5}{32 \div 50 \times 625.5 + 1000 \times 150} \times 0.191 = 5.08 \times 1 {0}^{- 4} kg / L$$

Using the functional relationship between the potassium chloride fertilizer concentration and E_{c} built into the control system:

$${E}_{c} = a {C}_{s} + b = 2.2441 \times 1 {0}^{6} \times 5.08 \times 1 {0}^{- 4} + 771.48 = 19 11.48 μS / cm$$

The set upper limit for the difference between the calculated value and the measured value in this instance is 10%. The conductivity sensor currently measures the E′ of the water-fertilizer mixture in the main irrigation pipeline of the moving lateral irrigation machine as 1987.83 μS/cm. Thus:

$$\frac{\vert 1 911.48 - 1987.83 \vert}{1987.83} = 3.84 \% \leq 10 \%$$

Therefore, the fertigation apparatus for the moving lateral irrigation machine is in a normal working state.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for fertigation in a moving lateral irrigation machine, characterized in that the control method is used for controlling fertigation equipment, where the fertigation equipment comprises an interconnected moving lateral irrigation machine, a fertilizer injection pump, and a fertilizer storage unit, the control method comprises:
acquiring inherent parameters of the irrigation machine, and setting for a current irrigation and fertilization event: a length of an irrigation field, a fertilizer application amount per hectare, an irrigation quota, and a fertilizer type;
collecting an inlet flow rate of the irrigation machine before starting the current irrigation and fertilization event, and an E_{c} value or pH value of clean water within a main pipeline of the irrigation machine;
based on the inherent parameters of the irrigation machine, the length of the irrigation field, the fertilizer application amount per hectare, the irrigation quota, the fertilizer type, and the inlet flow rate before starting fertilizer injection, calculating operational parameters for the irrigation machine and the fertilizer injection pump to form a strategy for the current irrigation and fertilization event; wherein the strategy specifically comprises dividing the irrigation field into a plurality of sub-fields and performing irrigation and fertilization operations on each sub-field sequentially; where for a currently operating sub-field, the irrigation and fertilization operations comprise: performing forward sprinkler fertigation, then performing reverse clean water sprinkler irrigation, and subsequently performing forward clean water sprinkler irrigation again; and where during the clean water sprinkler irrigation, a fertilizer solution required for a next stage is prepared;
controlling the fertigation equipment to execute the strategy for the current irrigation and fertilization event;
and during the execution of the strategy, monitoring and performing feedback adjustment of a concentration of a sprinkler-applied fertilizer solution, comprising: selecting a corresponding fertilizer concentration inversion prediction model based on the fertilizer type; obtaining a predicted E_{c} value or predicted pH value for the sprinkler-applied fertilizer solution in the current irrigation and fertilization event based on the sprinkler-applied fertilizer concentration and the selected fertilizer concentration inversion prediction model; comparing the predicted E_{c} value or predicted pH value with an E_{c} value or pH value of the sprinkler-applied fertilizer solution collected after fertilizer injection begins; and generating a control command for the Fertigation equipment based on a comparison result.

2. The control method as claimed in claim 1, characterized in that the inherent parameters of the irrigation machine comprise: a total length of the irrigation machine, a throw distance of an end sprinkler installed on the irrigation machine, a field water application efficiency, a field slip coefficient, a rated speed of a drive motor, an effective radius of a matched tire, a transmission ratio of a drive motor reducer, a transmission ratio of a wheel reducer, a rated frequency of the fertilizer injection pump, and a verified actual flow rate of the fertilizer injection pump.

3. The control method as claimed in claim 1, characterized in that the E_{c} value and the pH value are collected by a conductivity sensor and a pH sensor, respectively, installed downstream of a confluence of a fertilizer injection pipeline and the main pipeline of the irrigation machine, and where the Inlet Flow Rate is collected by a flow meter installed at a water inlet of the main pipeline of the irrigation machine.

4. The control method as claimed in claim 1, characterized in that specific steps for forming the strategy for the current irrigation and fertilization event comprise:
a preset program: determining a coverage area A₀ of the irrigation machine based on the inherent parameters of the irrigation machine;
for Sprinkler Fertigation: determining a total fertilizer injection volume V_{f} for a current Sprinkler Fertigation event based on a given maximum solubility S of the fertilizer at room temperature, the fertilizer application amount per hectare M, and the coverage area A₀ of the irrigation machine; determining a number of fertilizer preparation cycles N for the current Sprinkler Fertigation event based on the total fertilizer injection volume V_{f} and a volume Vₜ of a fertilizer storage container in the fertilizer storage unit, where a number of sub-fields divided by the irrigation field is set equal to the number of fertilizer preparation cycles N; determining an actual fertilizer injection volume V for the current sprinkler fertigation event based on the number of fertilizer preparation cycles N and the volume Vₜ of the fertilizer storage container; determining a length l and an area a of a single divided sub-field based on the length of the irrigation field L_{b}, the coverage area A₀ of the irrigation machine, and the number of fertilizer preparation cycles N for the current sprinkler fertigation event; determining a minimum time tₘᵢₙ for the irrigation machine to traverse a single sub-field in one direction based on the length l and a maximum travel speed of the irrigation machine; determining a percentage timer setting value x_{f} for the irrigation machine during a sprinkler fertigation process for the single sub-field based on the inlet flow rate Q₀ of the irrigation machine, a desired fertilizer solution depth h_{f} during sprinkler fertigation, the coverage area A₀ of the irrigation machine, and the minimum traversal time tₘᵢₙ for the single sub-field; calculating an operation duration tr for the irrigation machine during the sprinkler fertigation process for the single sub-field based on the minimum traversal time tₘᵢₙ and the percentage Timer setting value x_{f} for sprinkler fertigation; determining an operating frequency f for the Fertilizer Injection Pump based on a rated frequency f_{d} of the fertilizer injection pump, a verified actual flow rate q_{d} of the fertilizer injection pump, and the operation duration t_{f} for the sprinkler fertigation process for the single sub-field;
for clean water sprinkler irrigation: calculating a clean water irrigation depth h_{w} based on a current irrigation quota h and the desired fertilizer solution depth hr during sprinkler fertigation; determining a percentage timer setting value x_{w} for the irrigation machine during the clean water sprinkler irrigation process for the single sub-field based on the inlet flow rate Q₀ of the irrigation machine, the coverage area A₀ of the irrigation machine, the minimum traversal time tₘᵢₙ for the single sub-field, and the clean water irrigation depth h_{w}; calculating an operation duration t_{w} for the irrigation machine during the clean water sprinkler irrigation process for the single sub-field based on the minimum traversal time tₘᵢₙ and the percentage timer setting value x_{w} for clean water sprinkler irrigation; and
forming the strategy for the current irrigation and fertilization event based on the operation duration t_{f} for the irrigation machine during the sprinkler fertigation process for the single sub-field, the operating frequency f for the fertilizer injection pump, the operation duration t_{w} for the irrigation machine during the clean water sprinkler irrigation process per single sub-field, a total operation duration per single sub-field tₐ=t_{f}+t_{w}, and a total duration for the fertigation operation t=Ntₐ.

5. The control method as claimed in claim 4, characterized in that:
the coverage area A₀ of the irrigation machine is calculated according to the following formula:
$${A}_{0} = \frac{{L}_{b} [ {L}_{s} + 0.75 ( {R}_{1} + {R}_{2} ) ]}{1 {0}^{- 4}}$$
where Lₛ is the total length of the Irrigation Machine, and R₁ and R₂ are throw distances of end sprinklers installed on the irrigation machine, respectively; for a One-Side moving lateral irrigation machine, Lₛ is a distance from a main drive tower to an end sprinkler on a truss pipeline, and R₂ is taken as 0; for a Two-Side moving lateral irrigation machine, Lₛ is a distance between end sprinklers on both sides of a truss pipeline the two-side moving lateral irrigation machine;
the total fertilizer injection volume V_{f} for the current sprinkler fertigation event is calculated according to the following formula:
$${V}_{f} = \frac{{MA}_{0}}{S} \times k$$
where k is a coefficient set to ensure sufficient dissolution of fertilizer, taken as 1.3 to 1.6;
the actual fertilizer injection volume V for the current sprinkler fertigation event is calculated according to the following formulas:
$$V = {NV}_{t}$$
$$N = \frac{{V}_{f}}{{V}_{t}}$$
where N is the number of fertilizer preparation cycles for the current sprinkler fertigation event, and Vₜ is the volume of the fertilizer storage container in the fertilizer storage unit, and a value of N obtained by the above formula is rounded up to a nearest integer to serve as the number of fertilizer preparation cycles for the current sprinkler fertigation event;
the length l and the area a of the single sub-field are calculated according to the following formulas:
$$l = \frac{{L}_{b}}{N}$$
$$a = \frac{{A}_{0}}{N}$$
the minimum time tₘᵢₙ for the irrigation machine to traverse the single sub-field in one direction is calculated according to the following formulas:
$${t}_{min} = \frac{l}{{v}_{e}}$$
$${v}_{e} = \frac{2 π η nr}{{i}_{1} {i}_{2}}$$
where i₁ is a transmission ratio of a drive motor reducer; i₂ is a transmission ratio of a wheel reducer; n is a rated speed of a drive motor; r is an effective radius of a matched tire; η is a field slip coefficient, depending on tire tread, tire pressure, and soil compactness, taken as 0.92 to 0.97;
the percentage timer setting value x_{f} for the irrigation machine during the sprinkler fertigation process for the single sub-field is calculated according to the following formula and rounded down:
$${x}_{f} = 0.1 \frac{{Q}_{0} {η}_{p} {t}_{min}}{{ah}_{f}}$$
where ηₚ is a field water application efficiency, which correlates with wind speed, where ηₚ is taken as 0.8 to 0.9 when wind speed is below 3.4 m/s, and ηₚ is taken as 0.7 to 0.8 when wind speed is between 3.4 and 5.4 m/s; a value of the fertilizer solution depth h_{f} during the sprinkler fertigation process for the single sub-field must not be less than 5 mm;
the operation duration t_{f} for the irrigation machine during the sprinkler fertigation process for the single sub-field is calculated according to the following formula:
$${t}_{f} = \frac{{t}_{min}}{{x}_{f}}$$
the operating frequency f for the fertilizer injection pump is calculated according to the following formula:
$$f = \frac{V {f}_{d}}{{q}_{d} {t}_{f}}$$
the clean water irrigation depth h_{w} for a single sub-field is calculated according to the following formula:
$${h}_{w} = h - {h}_{f}$$
the percentage timer setting value x_{w} for the irrigation machine during the clean water sprinkler irrigation process for the single sub-field is calculated according to the following formula and rounded down:
$${x}_{w} = 0.2 \frac{{Q}_{0} {η}_{p} {t}_{min}}{{ah}_{w}}$$
the operation duration t_{w} for the irrigation machine during the clean water sprinkler irrigation process for the single sub-field is calculated according to the following formula:
$${t}_{w} = 2 \frac{{t}_{min}}{{x}_{w}}$$

6. the control method as claimed in claim 1, characterized in that, during the execution of the strategy for the current irrigation and fertilization event, monitoring and performing feedback adjustment of the fertilizer solution concentration specifically comprises:
calculating a concentration C of a stock fertilizer solution prepared in a fertilizer storage tank of the fertilizer storage unit during a sprinkler fertigation process of the irrigation machine according to the following formula:
$$C = \frac{M {A}_{0}}{V}$$
where C is the concentration of the stock fertilizer solution; M is the fertilizer application amount per hectare; A₀ is a coverage area of the irrigation machine; V is an actual fertilizer injection volume for a current sprinkler fertigation event;
calculating a concentration Cₛ of the sprinkler-applied fertilizer solution based on the inlet flow rate Q₀ of the irrigation machine, a verified actual flow rate q_{d} of the fertilizer injection pump, and the prepared stock fertilizer solution concentration, using the following formula:
$${C}_{s} = \frac{{q}_{d}}{{q}_{d} + 1000 {Q}_{0}} \times C$$
where Cₛ is the concentration of the sprinkler-applied fertilizer solution;
selecting a corresponding fertilizer concentration inversion prediction model based on the fertilizer type, where the fertilizer concentration inversion prediction model reflects a functional relationship between the sprinkler-applied fertilizer concentration Cₛ and an E_{c} value or a pH value of the sprinkler-applied fertilizer solution;
inputting the sprinkler-applied fertilizer concentration Cₛ into the fertilizer concentration inversion prediction model to obtain a predicted E_{c} value and a predicted pH value for the sprinkler-applied fertilizer solution in the current irrigation and fertilization event, and comparing the predicted E_{c} value or the predicted pH value with the E_{c} value or pH value of the sprinkler-applied fertilizer solution collected after fertilizer injection begins; if a comparison result exceeds a set threshold, issuing a stop signal and generating a stop report; if the comparison result does not exceed the set threshold, continuing execution of the strategy for the current irrigation and fertilization event until an operation duration of the irrigation machine reaches a total duration t for the fertigation operation, at which point the current irrigation and fertilization event concludes.

7. The control method as claimed in claim 6, characterized in that: when the selected fertilizer is a strong electrolyte, the fertilizer concentration inversion prediction model is:
$${E}_{c} = {aC}_{s} + b$$
where E_{c} is electrical conductivity; a is a first coefficient, which needs to be calibrated through experiments; b is the E_{c} value of the clean irrigation water before fertilizer injection begins;
when the selected fertilizer is an acidic or alkaline fertilizer, the fertilizer concentration inversion prediction model is:
$$pH = {y}^{{C}_{s}} + z - 1$$
where pH is acidity or alkalinity; y is a second coefficient, which needs to be calibrated through experiments; z is the pH value of the clean irrigation water before fertilizer injection begins.

8. The control method as claimed in claim 1, characterized in that the strategy for the current irrigation and fertilization event further comprises: performing a backwashing operation on the fertilizer injection pump during the clean water sprinkler irrigation phase after completing sprinkler fertigation for a final sub-field, by setting an operation duration t_{c} and a rated operating frequency f_{c} for the Fertilizer Injection Pump during the Backwashing process; where t_{c} is set as a fixed duration, typically 10 minutes; and where f_{c} is set to a rated frequency of the fertilizer injection pump.

9. A fertigation apparatus for a moving lateral irrigation machine, operable according to the control method of claim 8, characterized in that the fertigation apparatus comprises fertilizer application equipment, a main drive tower of the irrigation machine, a control system, and a plurality of pipelines, where: the fertilizer application equipment comprises the fertilizer injection pump and the fertilizer storage unit; the main drive tower comprises a traveling mechanism, a main tower frame mounted on the traveling mechanism, and a main irrigation machine pipeline mounted at a central portion of the main tower frame;
the fertilizer injection pump is connected via pipelines between the main irrigation machine pipeline and the fertilizer storage unit, and is configured to inject fertilizer solution from the fertilizer storage unit into the main irrigation machine pipeline based on control commands from the control system; where an inlet of the fertilizer injection pump is connected via a fertilizer suction pipeline to a fertilizer outlet at a bottom of a fertilizer storage tank within the fertilizer storage unit; an outlet of the fertilizer injection pump is connected via a fertilizer injection pipeline to the main irrigation machine pipeline; the main irrigation machine pipeline is connected via a water make-up pipeline to an inlet of the fertilizer storage tank; a backflush pipeline is connected between the water make-up pipeline and the fertilizer suction pipeline; and where the fertilizer injection pump is flushed via the backflush pipeline during the clean water sprinkler irrigation phase after completing sprinkler fertigation for a final sub-field;
the fertilizer storage unit is configured to prepare a fertilizer solution of a corresponding concentration based on the control commands from the control system, and comprises the interconnected fertilizer storage tank and a fertilizer mixer;
the control system comprises a sensor unit, a valve group, and a first control cabinet and a second control cabinet disposed on one side of the main tower frame in communication with each other;
the sensor unit comprises a liquid level sensor mounted at a top of the fertilizer storage tank, a pressure switch installed on the fertilizer injection pipeline, and a flow meter, a conductivity sensor, and a pH sensor sequentially installed on the main irrigation machine pipeline;
the valve group comprises a water make-up motorized valve, a fertilizer suction motorized valve, a fertilizer injection motorized valve, and a backflush motorized valve, respectively installed on corresponding pipelines;
the second control cabinet is configured to: calculate operational parameters for the irrigation machine and the fertilizer injection pump based on user-set parameters and an inlet flow rate of the irrigation machine collected by the flow meter before fertilizer injection begins, thereby forming a strategy for the current irrigation and fertilization event and displaying the strategy to the user; control operation of the fertilizer application equipment, the sensor unit, and the valve group according to the strategy for the current irrigation and fertilization event; and, during the control process, monitor and perform feedback adjustment of the concentration of the sprinkler-applied fertilizer solution;
the first control cabinet is configured to: control start or stop, travel speed, and operation time of the irrigation machine, and control start or stop of a main water supply pump for the irrigation machine, according to the strategy for the current irrigation and fertilization event.

10. The apparatus as claimed in claim 9, characterized in that: the second control cabinet comprises a frequency converter and a second controller disposed inside a second cabinet body, and a human-machine interface unit disposed on an exterior of the second cabinet body; the second control cabinet integrates an irrigation and fertilization strategy generation module and an irrigation fertilizer concentration control module; the second controller controls an operating frequency of the fertilizer injection pump via the frequency converter; and the second controller is connected to the sensor unit, the valve group, and the fertilizer mixer; the first control cabinet comprises a percentage timer and a first controller disposed on an exterior and inside a first cabinet body, respectively; the first controller and the second controller are in communication with each other; and the first controller controls the travel speed of the irrigation machine via the percentage timer;
a fertilizer suction filter and a fertilizer suction manual valve are further installed on the fertilizer suction pipeline; a water make-up filter and a water make-up manual valve are further installed on the water make-up pipeline; a check valve and a fertilizer injection manual valve are further installed on the fertilizer injection pipeline; and a manual drain valve is installed at a bottom of the fertilizer storage tank.
